(19) United States
(12) Patent Application Publication
(10) Pub. No.: US 2003/0231998 A1
(43) Pub. Date: Dec. 18, 2003

(54) Method for apparatus for treating sulfur dioxide containing gasses

(75) Inventor: Gordon M. Cameron, Burks Falls (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Cecebe Technologies Inc., Burks Falls (CA)

(21) Appl. No.: 10/171,995

(22) Filed: Jun. 17, 2002

(51) Int. Cl. B01D 53/60

(52) U.S. Cl. 423/244.09; 422/177; 422/170; 422/173

(57) ABSTRACT

A method comprises providing a first gas stream containing a first concentration of sulfur dioxide; passing the first gas stream through at least a first catalyst volume whereby at least a portion of the sulfur dioxide is reacted to produce sulfur trioxide and removing from the at least a first catalyst volume a first treated gas stream containing sulfur trioxide and unreacted sulfur dioxide wherein the reaction of sulfur dioxide to sulfur trioxide is not limited by catalyst volume; providing a second gas stream containing a second and higher concentration of sulfur dioxide; and, passing the first treated gas stream and the second gas stream through at least at least a second catalyst volume to produce a second treated gas stream containing sulfur trioxide and unreacted sulfur dioxide.

### FIELD OF THE INVENTION

This invention relates to the processing of sulfur dioxide containing gases. In one embodiment, this invention relates to the processing of waste gases from metallurgical processes, sulfur combustors or the like to remove sulfur dioxide therefrom and obtain sulfur dioxide, sulfur trioxide and/or sulfuric acid therefrom.

### BACKGROUND OF THE INVENTION

The conventional sulfuric acid contact process is based on once through treatment of dry process gases containing sulfur dioxide and enough excess oxygen to drive the catalytic conversion process to a high degree of completion. Where very stringent degrees of completion are needed, the process is often interrupted to remove the sulfur trioxide present so that an improved equilibrium can be approached with a significantly lower sulfur dioxide content in the unreacted process gasses. There are a number of limitations on the process that include having enough oxygen for both conversion and generating an acceptable equilibrium conversion and also managing the process in such a way that the temperatures which are obtained in the conversion process do not damage the catalyst.

Classic design of sulfuric acid contact plants has been based on experience with gases formed by burning sulfur in which the sum of the oxygen and sulfur dioxide contents add to 21%. The contact process as now typically practiced uses dry sulfur dioxide containing gases to which enough air has been added to furnish the oxygen for conversion of the sulfur dioxide to sulfur trioxide together with enough extra oxygen to create a final equilibrium conversion in which a very low concentration of sulfur dioxide is achieved. For plants in which sulfur is burned with air and there is a single stage of sulfur trioxide removal, [the single absorption process], the normal gas feed strength is 8 percent sulfur dioxide and 13 percent oxygen and the tail gas will contain less than 0.2 percent sulfur dioxide.

FIG. 1 is a typical gas flow diagram for a single stage absorption plant using metallurgical gas [i.e. gas obtained from, e.g., a smelting process]. The smelting operation may generate a plurality of waste gas streams 12 from roasters, furnaces or converters, each of which contains sulfur dioxide. Gas streams 12 are combined to form a combined waste gas stream 14, which is fed it to pre-treater 16. At pre-treater 16, combined waste gas stream 14 is subjected to dry gas cleaning techniques known in the art and then scrubbed to form a saturated sulfur dioxide containing gas which is mixed, if necessary, with air to form a wet process gas. This wet process gas is then dried using sulfuric acid as a desiccant. Typically, the gas cleaning and drying equipment of pre-treater 16 is operated under vacuum. Accordingly, pretreated waste gas 18 is fed to blower 20, which is located downstream of pretreater 16, which provides enough pressure to force the gas through the converter system comprising, in this case, the exchangers 28, 30, 32 and the converter 22 and through the acid plant absorber which is not shown.

From blower 20, the waste gas flows through several heat exchangers [e.g. heat exchangers 28, 30 and 32] to preheat the gas to reaction temperature prior to the first catalyst bed 26. Typically, first catalyst bed 26 inlet gas temperatures range from 380 to 430 degrees centigrade and the temperature of exit gas stream 34 ranges from 550 to 625 degrees centigrade. At temperatures above about 625 degrees centigrade, catalyst, converter and heat exchanger life is significantly shortened. Accordingly, the gas strength of waste gas stream 18 is normally kept below 12% sulfur dioxide. Exit gas stream 34 is passed through first heat exchanger 28 to produce cooled reacted gas stream 36 which is fed to the second catalyst bed 26. Second exit gas stream 38 is obtained from second catalyst bed 26 and passed through second heat exchanger 30 to obtain second cooled reacted gas stream 40. Second cooled reacted gas stream 40 is fed to the third catalyst bed 26 to obtain third exit gas stream 42. Third exit gas stream 42 is fed through the third heat exchanger 32 to obtain cooled product gas stream 44. While FIG. 1 shows three catalyst beds 26, four or five beds are more common. In addition, as shown in FIG. 2, many plants now absorb sulfur trioxide between the third and fourth catalyst beds 26 so that a new equilibrium can be obtained between the residual oxygen and sulfur dioxide in the last catalyst beds 26 thus decreasing sulfur dioxide emissions.

In new plants sulfur trioxide is removed in two stages [the double absorption process]. Sulfur trioxide builds up in the gas stream as the gas stream passes through the catalyst beds. The first stage absorption process to remove some of the build up sulfur trioxide occurs after the second or third catalyst bed and removes in excess of 90 percent of the sulfur trioxide. This allows the gas to approach a new equilibrium unaffected by the previously removed sulfur trioxide during the passage of the gas stream through subsequent catalyst beds. In such a case, the overall gas strength entering the plant is commonly increased to around 11.5% sulfur dioxide with 9.5% oxygen and the tail gas will have a sulfur dioxide content of less than 350 ppm of sulfur dioxide, corresponding to an overall efficiency of 99.7% which compares to 98% for the single absorption process. Under the conditions in these two processes, there is a significant flow of nitrogen through the process due to the air used. This nitrogen must be heated in each catalyst bed and accordingly moderates the temperature rise. The predominant use of the double absorption process with a sulfur feed and air has resulted in catalysts being developed with these temperature constraints as limits.

Several other processes also generate sulfur dioxide containing gases and the stoichiometry may be very different. One major source is the incineration of waste acids. In such processes, waste acids are thoroughly decomposed by hot gases obtained from hydrocarbon combustion and the mixed gases are often quite dilute, well below the gas strengths obtained from the combustion of sulfur. In some cases, these plants may use a significant amount to sulfur as fuel and gas strengths may rise beyond the levels of sulfur burner gas but such operations are not common. A further version that can be found is the use of tonnage oxygen to combust the hydrocarbons in the waste acid furnaces in which case the gas strength rises significantly and the gas volume decreases. These last two cases can result in gases that are somewhat stronger than sulfur burner gas but are currently typically treated in a similar manner to sulfur burner gas.

A more important source of strong gases is the smelting of ores using oxygen flash smelting techniques instead of air. Typically, in the classic smelting of sulfide ores, sulfur dioxide gas and an oxide slag/product are formed. If air is used, typically two-thirds of the oxygen ends up in the exhaust gas and one-third is combined in the metal oxide. In order to recover the sulfur dioxide as sulfuric acid, more air then has to be added to provide not only the oxygen for the reaction but also the extra oxygen to create the proper conversion of sulfur dioxide to sulfur trioxide. Such plants typically operate with gas strengths below 8% sulfur dioxide, which is below the level found in sulfur burner plants.

With the increasing costs of fuel, and pressures to removed sulfur oxides from the atmosphere, the use of oxygen as a substitute for air or for enriching air, has become common in smelters. For the smelter operator, the heat previously carried out of the smelting furnaces by hot nitrogen in the furnace off-gases is no longer being lost and, accordingly, more of the heat produced by the oxidation of sulfide to sulfur dioxide is directed to melting the concentrate. The concentrate can also be reacted to a higher degree than with previous techniques, reducing the load on pyrometallurgical operations, which now include oxygen as the raw material.

With tonnage oxygen, the smelter off-gases are now often much more concentrated than the gases obtained by burning sulfur in the air and stronger gases are available for use in acid plants. Several approaches have been used to handle stronger gases. However, the primary problem is the very high temperature rise in the initial catalyst bed and the damage it does to catalyst and converter vessels and the downstream gas exchanger.

For example, one approach is to use a pre-converter in which a part of the gas stream is contacted with a limited catalyst bed to create a partially converted gas which is then mixed with the remainder of the gas stream and fed to the first catalyst bed with sulfur trioxide already present to limit the temperature rise in the first catalyst bed. Referring to FIG. 2, a plant schematic is shown which utilizes a pre-converter. In this embodiment, pretreated gas stream 18 is fed through blower 20 and through passage 24 to pre-converter 52. The exit gas from pre-converter 52 is combined with the remaining unreacted gas in feed gas stream 54 to produce first treated gas stream 56. While the concentration of sulfur oxides in gas stream 56 may be relatively high bracket [e.g. 14 to 15% by volume], the presence of sulfur trioxide that was produced in pre-converter 52 limits the temperature rise in the downstream catalyst beds. First treated gas stream 56 is fed through first heat exchanger 58 to produce first cooled gas stream 60 which is fed to the first catalyst bed 26 to produce second exit gas stream 62. Second exit gas stream 62 is fed through second heat exchanger 64 to produce second cooled gas stream 66, which is fed to the second catalyst bed 26 to produce third exit gas stream 68. Third exit gas stream 68 passes through third heat exchanger 70 to obtain third cooled gas stream 72 which is fed to the third catalyst bed 26 to obtain fourth exit gas stream 74. Fourth exit gas stream 74 may be subjected to further treatment (e.g. a sulfur trioxide removal step) before passing through one or both of fourth heat exchanger 76 and third heat exchanger 70 to obtain fourth cooled gas stream 78 which is fed to the fourth catalyst bed 26 to obtain fifth exit gas stream 80. Fifth exit gas stream 80 is fed through fifth heat exchanger 82 to produce cooled product gas stream 84.

The difficulty with this approach is that the catalyst in the pre-converter is sacrificial, as the catalyst in it will normally approach relatively closely to a very high temperature equilibrium. If it is proposed to end the conversion of this pre-converter well away from equilibrium, then control becomes difficult, as the strength of the feed gas is already variable as a result of the metallurgical operation.

In an alternate approach, the gas strength in a plant has simply been allowed to rise and the higher temperatures accepted. This plant has been in operation for over five years and has experienced significant operating and maintenance problems in and downstream of the pre-converter catalyst bed. Although the gas in this plant is strong, there is still more than enough oxygen for conversion and occasional rises in gas strength due to fluctuations in flow add to the difficulty of the operations.

In a further alternate approach, an older plant using strong gas sources has now been in operation for over 10 years and has succeeded by adding sufficient dilution air to dilute the sulfur dioxide content to 12% sulfur dioxide, the limit in sulfur burning plants. In this plant, unlike the sulfur burning plant, the oxygen content entering the first bed is over 15% compared with 9% for a sulfur burner plant, and the catalyst is more reactive and rises to higher equilibrium temperature.

### SUMMARY OF THE INVENTION

In accordance with the instant invention, it has been surprisingly found that the converter bed temperature limitation and the overall gas strength limitation set by the initial catalyst step or steps can be overcome by utilizing feed gas streams, namely a first gas stream consisting of gas containing sulfur dioxide and oxygen and compatible with the simple use of the gas in the first catalyst bed without overheating the catalyst, and a second more concentrated stream which can be added after the first catalyst bed and before the second catalyst bed. In this way, an initial conversion of sulfur dioxide to sulfur trioxide can be achieved without risking the catalyst in a pre-converter. The feed gas stream for the second catalyst bed [namely the second more concentrated stream and the gas stream from the initial conversion step] has sufficient sulfur trioxide to limit the temperature rise in the second catalyst bed to acceptable levels even with much higher sulfur dioxide concentrations, up to the limits of gas composition which would be set by a the overall conversion constraints.

By operating a process in accordance with this invention, some or all of the strong gas [e.g., with the sulfur dioxide concentration of from about 13 to about 24%, based on volume, and with the oxygen concentration of from about 11 to about 18%, based on volume] may be used to produce sulfuric acid without dilution. By reducing or eliminating the amount of dilution air that must be added, the size of acid plant equipment, and its attendant cost, may be reduced. In addition, the operating cost of acid plants may be reduced as smaller volumes of gas travel through the equipment. For example, modern large smelter acid plants may consume 10 to 15 MW of power simply to pump fluids through the plant.

A further advantage of the instant process is that a greater amount of heat may be recovered from the system. In a typical acid plant, the amount of dilution air that must be added results in the temperature of the waste gas being sufficiently low so that efficient and reliable energy recovery is not practical. By avoiding the use of such large volumes of dilution air, the operating temperature of the process may be higher, thus permitting heat recovery and, therefore, an improvement in the overall economics of the process.

A further advantage of the instant process is that the amount of sulfur dioxide released to the atmosphere may be reduced. One of the regulatory requirements for acid plant emissions is the stack gas composition [i.e. the concentration of pollutants in the waste gas] and not the total emission of pollutants from the plant. The low gas strength needed in typical acid plants requires a large quantity of dilution air. Thus the total volume of stack gas is relatively large and carries a substantial amount of sulfur dioxide into the atmosphere even despite low levels of sulfur dioxide in the stack gas. The process of the instant invention emits lower amounts of stack gasses [since less or no dilution air may be required] and, in addition, may result in the stack gas have an even lower quantity of sulfur dioxide.

In accordance with the instant invention, there is provided a method comprising:

(a) providing a first gas stream containing a first concentration of sulfur dioxide;

(b) passing the first gas stream through at least a first catalyst volume whereby at least a portion of the sulfur dioxide is reacted to produce sulfur trioxide and removing from the at least a first catalyst volume a first treated gas stream containing sulfur trioxide and unreacted sulfur dioxide wherein the reaction of sulfur dioxide to sulfur trioxide is not limited by catalyst volume;

(c) providing a second gas stream containing a second concentration of sulfur dioxide; and,

(d) passing the first treated gas stream and the second gas stream through at least a second catalyst volume to produce a second treated gas stream containing sulfur trioxide and unreacted sulfur dioxide.

In one embodiment, the second concentration is higher than the first concentration.

In another embodiment, the second concentration is greater than about 12% sulfur dioxide.

In another embodiment, the first and second gas streams are obtained from different sources.

In another embodiment, the first and second gas streams are obtained from different stages of a smelting operation.

In another embodiment, the first gas stream is diluted to reduce the concentration of sulfur dioxide to a concentration at which the first catalyst volume will not overheat.

In another embodiment, a feed stream containing sulfur dioxide is split to produce the first and second gas streams wherein sulfur dioxide concentration of the first and second streams is varied by a step selected from the group consisting of diluting the first stream to reduce the concentration of sulfur dioxide, increasing the concentration of sulfur dioxide in the second stream and a combination of both.

In another embodiment, the first and second gas streams are separately dried before contacting a catalyst volume.

In accordance with the instant invention, there is also provided a method comprising:

(a) obtaining a first gas stream containing a first concentration of sulfur dioxide from a first source of sulfur dioxide;

(b) subjecting the first gas stream to catalysis to produce a first treated gas stream containing sulfur trioxide and sulfur dioxide;

(c) obtaining a second gas stream containing a second concentration of sulfur dioxide from a second source of sulfur dioxide; and,

(d) subjecting the first treated gas stream and the second gas stream together to catalysis to produce a second treated gas stream containing sulfur trioxide and sulfur dioxide.

In one embodiment, each of the first and second gas streams is separately pretreated before being subjected to catalysis. Preferably, the pretreatment step includes a drying step.

In accordance with the instant invention, there is also provided an apparatus comprising:

(a) a first catalyst bed;

(b) a first gas stream passage positioned upstream from the first catalyst bed and connecting in fluid flow communication a first source of sulfur dioxide with the first catalyst bed;

(c) a second catalyst bed positioned downstream from the first catalyst bed;

(d) a treated gas passage connecting the first and second catalyst beds in fluid flow communication; and,

(e) a second gas stream passage positioned upstream from the second catalyst bed and connecting in fluid flow communication a second source of sulfur dioxide with the second catalyst bed.

In one embodiment, the second gas stream passage communicates with the second catalyst bed via the treated gas passage.

In another embodiment, the concentration of sulfur dioxide in the second source of sulfur dioxide is higher than the concentration of sulfur dioxide in the first source of sulfur dioxide.

In another embodiment, the concentration of sulfur dioxide in the second source of sulfur dioxide is greater than about 12% sulfur dioxide.

In another embodiment, the first and second sources of sulfur dioxide are obtained from different stages of a smelting operation.

In another embodiment, gas from the first source of sulfur dioxide is diluted to reduce the concentration of sulfur dioxide to a concentration at which the first catalyst bed will not overheat.

In another embodiment, the apparatus further comprises a first dryer upstream from the first catalyst bed for drying gas from the first source of sulfur dioxide and a second dryer for drying gas from the second source of sulfur dioxide.

In accordance with the instant invention, there is also provided an apparatus comprising:

(a) a first catalyst bed;

(b) a first gas stream passage positioned upstream from the first catalyst bed and in fluid flow communication with the first catalyst bed, the first gas stream passage providing sulfur dioxide to the first catalyst bed, the first catalyst bed having a volume of catalyst which does not limit conversion of sulfur dioxide to sulfur trioxide;

(c) a second catalyst bed positioned downstream from the first catalyst bed;

(d) a treated gas passage connecting the first and second catalyst beds in fluid flow communication; and,

(e) a second gas stream passage positioned upstream from the second catalyst bed and in fluid flow communication with the second catalyst bed, the second gas stream passage providing sulfur dioxide, which has not passed through the first catalyst bed, to the second catalyst bed.

In one embodiment, the second gas stream passage communicates with the second catalyst bed via the treated gas passage.

In another embodiment, gas having a first concentration of sulfur dioxide is provided to the first catalyst bed and gas having a higher concentration of sulfur dioxide is provided to the second catalyst bed.

In another embodiment, the first gas stream passage is in fluid flow communication with a different source of sulfur dioxide then the second gas stream passage.

In another embodiment, the apparatus further comprises a first dryer upstream from the first catalyst bed and a second dryer upstream from the second catalyst bed.

### BRIEF DESCRIPTION OF THE DRAWINGS

For a better understanding of the present invention and to show more clearly how it may be carried into effect, reference will now be made by way of example to the accompanying drawings, of the preferred embodiments of the present invention, in which:

FIG. 1 is a schematic drawing of a typical gas flow diagram of a single stage absorption plant using metallurgical gas as is known in the art;

FIG. 2 is a schematic drawings of a plant that uses a pre-converter as is known in the art;

FIG. 3 is a schematic drawing of a plant according to the one embodiment of the instant invention;

FIG. 4 is a schematic drawing of a plant according to another embodiment of the instant invention;

FIG. 5 is a schematic drawing of a process to obtain the feed gas for the process of FIGS. 3 and 4; and,

FIG. 6 is a schematic drawing of a metallurgical process to obtain the feed gas for the process of FIGS. 3 and 4.

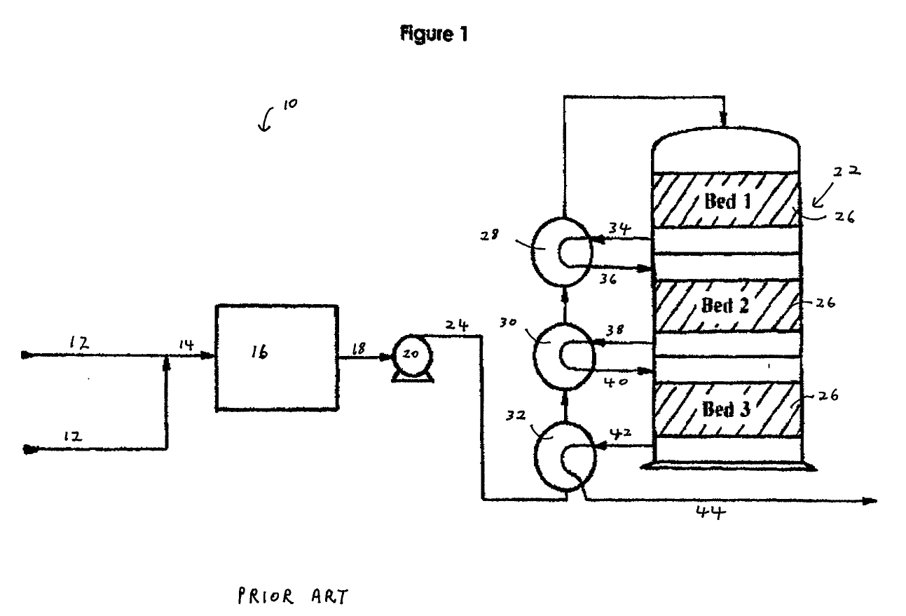

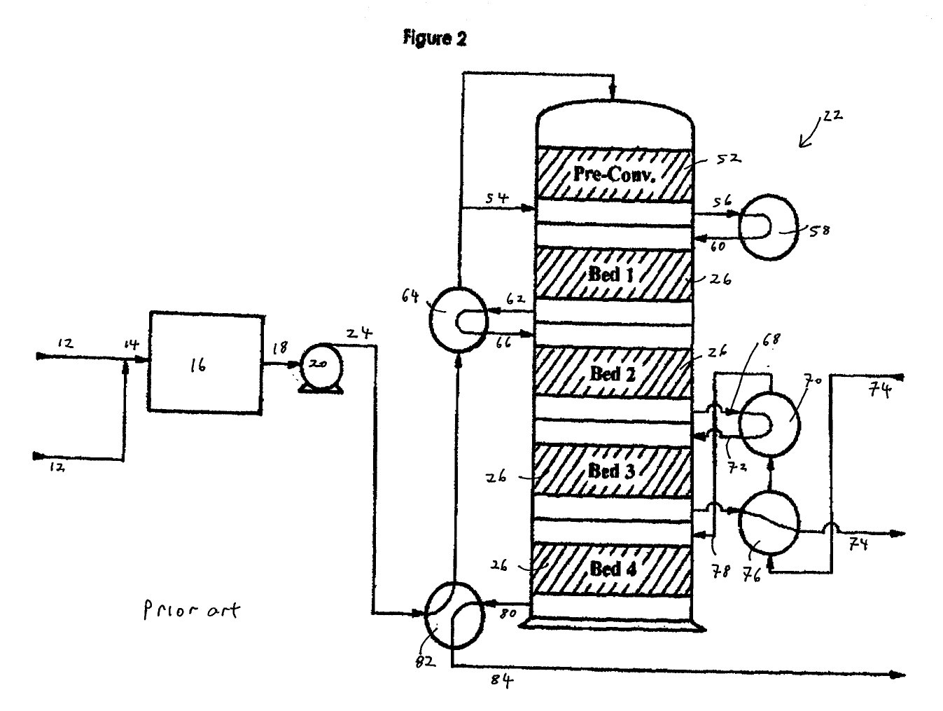

### DETAILED DESCRIPTION OF THE INVENTION

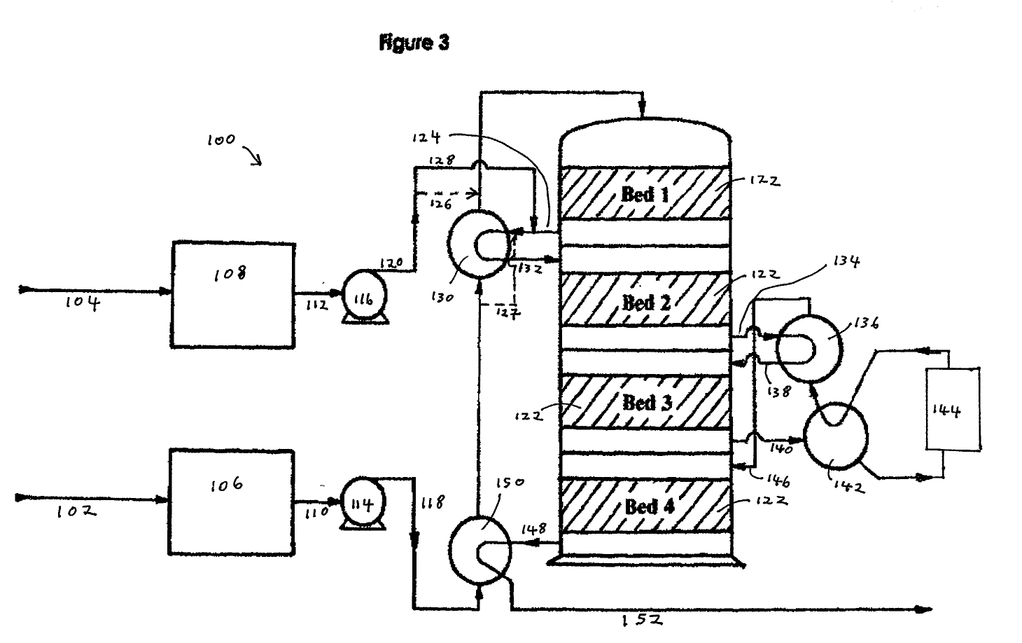

FIG. 3 shows a schematic drawing of the sulfur trioxide production portion of a sulfuric acid plant incorporating the method and apparatus of the instant invention. Pursuant to the instant invention, at least two feed streams of gas containing sulfur dioxide are obtained and optionally separately pretreated in pretreaters to obtain pretreated streams which are then fed through a plurality of catalyst beds or volumes of catalyst such that at least a portion of the sulfur dioxide, and preferably essentially all of the sulfur dioxide, is converted to sulfur trioxide. The number and sequence of catalyst beds through which the pretreated streams are passed may be varied as is known in the art, provided that the first catalyst bed does not receive all of the at least two feed streams of gas containing sulfur dioxide. It will be appreciated that the use of additional catalyst beds, as well as the interim removal of sulfur trioxide, will increase the amount of sulfur dioxide that is converted to sulfur trioxide and, accordingly, reduce the amount of sulfur dioxide which is emitted from the plant.

In the preferred embodiment of FIG. 3, two sulfur dioxide feed streams 102, 104 are utilized. Each feed stream 102, 104 is optionally separately pretreated in a pretreater 106, 108 to obtain pretreatment streams 110, 112. The pretreatment steps may be any that are known in the sulfuric acid production of art. Preferably, the pretreatment includes cleaning and drying the sulfur dioxide containing gas in preparation for its catalytic conversion to sulfur trioxide. Two separate pretreaters 106 and 108 are used so that streams 102 and 104 are not commingled. It will be appreciated that only one pretreater may be used if streams 102 and 104 are fed separately through the pretreater in which case storage vessels will be required if a continuous operation is to be maintained. It will be appreciated that each of streams 102 and 104 may be obtained by combining a plurality of streams, which may be obtained from different sources.

Each feed stream 102, 104 contains a different concentration of sulfur dioxide. The concentration of the feed stream fed to the first catalyst bed 122 is set such that the catalyst in the first catalyst bed 122 will not overheat. Accordingly, the feed stream fed to the first catalyst bed 122 may contain from about 8 to about 13, preferably from about 10 to about 12 and more preferably from about 11 to about 12% by volume sulfur dioxide and from about 9 to about 18, and preferably from about 9 to about 15 by volume oxygen. The volume of catalyst in the first catalyst bed 112 is preferable set so that the reaction of sulfur dioxide to sulfur trioxide is not limited by the amount of catalyst in the first catalyst bed 122.

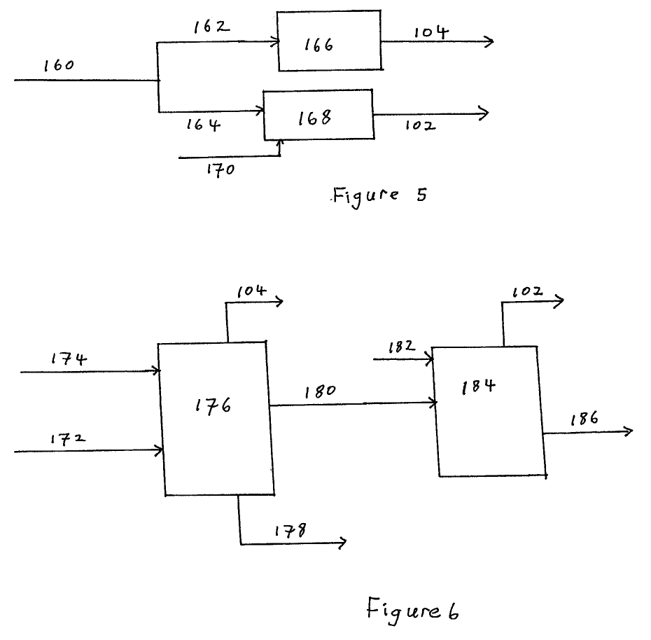

Feed streams 102, 104 of may be obtained in a variety of manners provided they have different concentrations of sulfur dioxide. For example, as shown in the embodiment of FIG. 5, a single sulfur dioxide containing stream 160 may be initially obtained. This stream may be pretreated and then split into two portions 162 and 164. The concentration of at least one of the divided out streams 162 and 164 is adjusted to obtain feed streams 102 and 104. For example, the initial sulfur dioxide containing stream may be concentrated [e.g. above about 8 volume percent sulfur dioxide], in which case one of the divided out streams may be diluted in dilution step 168 with air, oxygen, oxygen enriched air or any other suitable dilution gas 170 to obtain first feed stream 102. Alternately, if the initial sulfur dioxide containing stream is weak, then divided out stream 162 may be concentrated by, e.g., air separation techniques, in concentration step 166 to produce second feed stream 104. In a still further alternate embodiment, one of the divided out streams may be diluted to obtain first feed stream 102 and the other divided out stream may be concentrated to obtain second feed stream 104.

In the alternate preferred embodiment shown in FIG. 6, feed streams 102 and 104 are obtained from a metallurgical process and, more preferably, from a smelter handling sulfide ores. For example, the smelter may contain one or more flash smelting furnaces 176 in which sulfide concentrate 172 is contacted with oxygen 174 to form a slag stream 178 containing essentially iron oxide, a matte stream 180 comprising metal sulfides, some remaining iron and sulfur, and gaseous effluent 104 consisting mainly of sulfur dioxide with some nitrogen, oxygen and miscellaneous contaminants. In such a case, the molten matte is then further reacted in a reactor 184 with air, enriched air, or oxygen 182 to form the molten metal or other the final product 186 and a gas stream 102 containing the remaining sulfur values as sulfur dioxide with other common gases. The second stream will typically contain about one-third of the sulfur dioxide emissions with significantly more dilutants than the stream from the flash smelting furnace.

The gas streams from reactors 176 and 184 may be fed directly into the process of the instant invention. Alternately, one or both of the streams 102 and 104 may be subjected to a pretreatment step. Gasses from both of the effluent streams from reactors 176 and 184 are preferably cleaned and dried separately [e.g., in pretreaters 106 and 108]. However, part of the effluent from the flash furnace 176 may be combined with the effluent stream from reactor 184 if the stoichiometry permits. For example, a portion of the effluent from flash furnace 176 may be combined with the effluent from reactor 184 so as to increase the concentration of stream 102.

If dilution air is required for the overall process, then the dilution air may be added to the effluent stream from reactor 184, the effluent from flash furnace 176 or both. Preferably, the dilution air, if required, is added to the effluent from reactor 184 so as not to dilute the strong gas that is obtained from flash furnace 176. For example, the effluent gas stream from 184 may contain up to 12% by volume sulfur dioxide and significantly more oxygen by volume then in the effluent from flash furnace 176.

Referring again to FIG. 3, subsequent to the preferred cleaning step, the strong and dilute gases [pretreated streams 112 and 110 respectively] are fed, such as by passing them through blowers 116 and 114 respectively, to the acid plant via streams 120 and 118. Dilute pretreated gas stream 110 is preferably preheated as is known in the art to a suitable temperature for catalytic conversion in the first catalyst bed 122. As shown in FIG. 3, a portion of pretreated strong gas stream 112 may also be fed to the first catalyst bed 122 via stream 126 [which may be combined with stream 118 or fed separately into first catalyst bed 122].

In first catalyst bed 122, from about 50 to about 75, and preferably about two-thirds of the sulfur dioxide in the gas fed to the first catalyst bed 122 is converted into sulfur trioxide. Preferably, the gas that is fed to the first catalyst bed 122 has as much sulfur dioxide and oxygen as is compatible with conversion in a first catalyst bed within the temperature limits normally observed in sulfuric acid plants. The temperature of the exit gas from the first catalyst bed 122 may vary from about 550 to about 650 degrees centigrade and, preferably, is about 600 degrees centigrade.

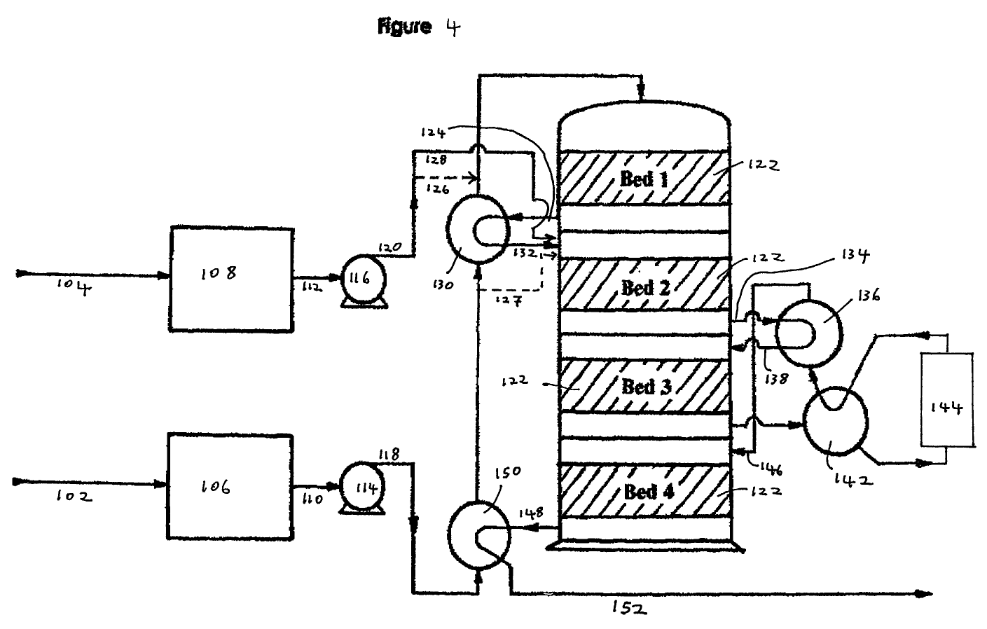

First exit gas stream 124, which is the first treated stream, is passed through first heat exchanger 130 to obtain first cooled stream 132. First cooled stream 132 is fed to the second catalyst bed to produce second exit gas stream 134, which is the second treated stream. Subsequent to first catalyst bed 122, all of the remaining strong gas stream is fed to one more of the subsequent catalyst beds is 122. As shown in FIG. 3, all of the remaining strong gas stream is fed by stream 128 to a point up stream of first heat exchanger 130 where it is combined with exit gas stream 124. Alternately, as shown in FIG. 4, all of the remaining strong gas stream is fed by stream 128 directly into the second catalyst bed 122. It will be appreciated by those skilled in the art that none or only a portion of the remaining strong gas stream 112 may be fed directly [e.g., as shown in FIG. 4] or indirectly [e.g., as shown in FIG. 3] to the second catalyst bed 122 and the remaining portion may be fed to one a more of the catalyst beds 122 down stream from the second catalyst bed 122. In a most preferred embodiment, all of strong gas stream 112 not fed to the first catalyst bed 122 is fed to the process upstream of second catalyst bed 122. In a further alternate embodiment, a portion of the dilute gas stream may be fed to the catalyst beds after bypassing the first catalyst bed 122. This alternate embodiment may be utilized if the volume of dilute gas stream 110 is greater than the capacity of first catalyst bed 122. Pursuant to this alternate embodiment, a portion of dilute stream 110 may be fed to the second catalyst bed 122 by bypass stream 127 (see FIGS. 3 and 4). The addition of a portion of the dilute gas stream 110 will reduce the overall concentration of strong gas stream 112. However, even in this case, the concentration of the feed gas which has not been catalytically treated (i.e., strong gas stream 112 either alone or in combination with a portion of the dilute gas stream 110 that by passed the first catalyst bed 122), which is mixed with the treated dilute gas stream provided to the second catalyst bed 122 (i.e. gas stream 132), is greater than the concentration of dilute gas stream 110.

The feed stream fed to the second catalyst bed 122 may contain from about 12 to about 24, preferably from about 14 to about 18 and more preferably from about 14 to about 16% by volume sulfur dioxide and from about 13 to about 18, preferably from about 12 to about 15 and more preferably from about 9 to about 13% by volume oxygen. It will be appreciated that depending upon the concentration of strong gas stream 112, strong gas stream 112 may be diluted if additional gas volume is required or metered at a sufficient rate to obtain a desirable conversion level in the second catalyst bed 122. As first cooled gas stream 132 already contains sulfur trioxide, the effect of the stronger gas on the temperature rise in second catalyst bed 122 is limited by the sulfur trioxide present in the feed gas to the second catalyst bed 122. Preferably, the overall gas composition of the gas fed to the second catalyst bed 122 is limited by the need to have enough oxygen in the last catalyst bed 122 to reduce the sulfur dioxide content to levels compatible with permitted emission levels.

Second exit gas stream 134 may then be treated as is known in the art. For example, it may pass through a series of conventional catalyst, exchanger and absorption steps until an appropriate gas is generated for venting to the atmosphere. For example, as shown in FIGS. 3 and 4, second exit gas stream 134 is passed through second heat exchanger 136 to produce second cooled stream 138, which is fed to third catalyst bed 122 to produce third exit gas stream 140. Third exit gas stream 140 is passed through third heat exchanger 142 and is then preferably subjected to a sulfur trioxide absorption process 144. The effluent from sulfur trioxide absorption process 144 is passed optionally through third heat exchanger 142 and second heat exchanger 136 to obtain third cooled gas stream 146 which is fed to fourth catalyst bed 122. Fourth exit gas stream 148 is removed from fourth catalyst bed 122 and passed through fourth heat exchanger 150 to obtain cooled product gas stream 152.

Assuming the sulfur dioxide gas content is reduced to conventional levels of 250 to 350 ppm, there will be an overall reduction in sulfur dioxide emissions by using the method and apparatus of the instant invention as the total quantity of stack gas may be around 70 percent of conventional emissions, and overall efficiency as well may be significantly higher, and a preferably it may be up to about 99.9% compared with present targets of 99.7%.

Conventional acid plants are limited in the gas strengths they can process by the need on the one hand to have enough excess oxygen to drive the conversion process to the extent needed to meet environmental emission limits and the need to avoid overheating the first catalyst bed. Until recently, the common limits were set to based on the combustion of sulfur in air and 12 percent sulfur dioxide with 9 percent oxygen resulted, giving an oxygen content in the tail gas of 4%. With most metallurgical processes using air to provide the oxygen, the gases were more dilute as part of the oxygen ended up as metal oxides in slag or metal product. The introduction of flash smelting dramatically changed the stoichiometric relationships in the gas feed to acid plants. With essentially pure oxygen as a feed, the gas streams from metallurgical processes may contain as high as 80 percent sulfur dioxide with some oxygen. If dilution air is added to produce the same exit oxygen levels from the converter system as in sulfur burning plants, then the overall gas composition of the feed gas to the converter would be in the range of 19 to 20% by volume sulfur dioxide which would result in an extremely hot catalyst if used directly in an acid plant. To date, the solution that has been utilized is to add enough air to dilute the feed gas to about 12%. The instant invention permits the gas feed to the first catalyst bed to be provided at standard strengths [e.g. up to 12%] and then it adds the remaining strong gas, which has been generated as a separate stream, resulting in a gas feed to the second catalyst bed which is essentially full strength. In the second catalyst bed, the unconverted sulfur dioxide is diluted by the sulfur trioxide formed in the first catalyst bed thus preventing the second bed from overheating. Beyond the second bed, gas handling can proceed using normal practice.

One advantage of the instant invention is that the catalyst bed temperatures in the first and second catalyst beds can be limited to safe long-term values independent of the overall gas strength used. Longer equipment life and more reliable operation are a direct result of easing the severity of conditions in the first catalyst bed. A second advantage is that the overall gas strength used in the process may be higher and the volume of gas handled is significantly decreased with savings in both capital and operating costs. A third advantage is that the overall process may operate on an overall basis at higher temperatures and facilitates energy recovery from the gas streams. A fourth advantage is that a higher sulfur trioxide gas composition may be obtained which allows higher strength oleum to be produced. A fifth advantage is that a separate high strength sulfur dioxide gas stream is required which could lead easily to producing a liquid sulfur dioxide stream if needed to trim the acid plant or for other purposes.

It will be appreciated by one skilled in the art that various additions and modifications may be made to the formation treating fluid disclosed herein and each is within the scope of this invention.

1. A method comprising:
(a) providing a first gas stream containing a first concentration of sulfur dioxide;
(b) passing the first gas stream through at least a first catalyst volume whereby at least a portion of the sulfur dioxide is reacted to produce sulfur trioxide and removing from the at least a first catalyst volume a first treated gas stream containing sulfur trioxide and unreacted sulfur dioxide wherein the reaction of sulfur dioxide to sulfur trioxide is not limited by catalyst volume;
(c) providing a second gas stream containing a second concentration of sulfur dioxide; and, (d) passing the first treated gas stream and the second gas stream through at least a second catalyst volume to produce a second treated gas stream containing sulfur trioxide and unreacted sulfur dioxide.

2. The method as claimed in claim 1 wherein the second concentration is higher than the first concentration.

3. The method as claimed in claim 1 wherein the second concentration is greater than about 12% sulfur dioxide.

4. The method as claimed in claim 1 wherein the first and second gas streams are obtained from different sources.

5. The method as claimed in claim 1 wherein the first and second gas streams are obtained from different stages of a smelting operation.

6. The method as claimed in claim 1 wherein the first gas stream is diluted to reduce the concentration of sulfur dioxide to a concentration at which the first catalyst volume will not overheat.

7. The method as claimed in claim 1 wherein a feed stream containing sulfur dioxide is split to produce the first and second gas streams wherein sulfur dioxide concentration of the first and second streams is varied by a step selected from the group consisting of diluting the first stream to reduce the concentration of sulfur dioxide, increasing the concentration of sulfur dioxide in the second stream and a combination of both.

8. The method as claimed in claim 1 wherein the first and second gas streams are separately dried before contacting a catalyst volume.

9. A method comprising:
(a) obtaining a first gas stream containing a first concentration of sulfur dioxide from a first source of sulfur dioxide;
(b) subjecting the first gas stream to catalysis to produce a first treated gas stream containing sulfur trioxide and sulfur dioxide;
(c) obtaining a second gas stream containing a second concentration of sulfur dioxide from a second source of sulfur dioxide; and,
(d) subjecting the first treated gas stream and the second gas stream together to catalysis to produce a second treated gas stream containing sulfur trioxide and sulfur dioxide.

10. The method as claimed in claim 9 wherein each of the first and second gas streams is separately pretreated before being subjected to catalysis.

11. The method as claimed in claim 10 wherein the pretreatment includes drying.

12. An apparatus comprising:
(a) a first catalyst bed;
(b) a first gas stream passage positioned upstream from the first catalyst bed and connecting in fluid flow communication a first source of sulfur dioxide with the first catalyst bed;
(c) a second catalyst bed positioned downstream from the first catalyst bed;
(d) a treated gas passage connecting the first and second catalyst beds in fluid flow communication; and,
(e) a second gas stream passage positioned upstream from the second catalyst bed and connecting in fluid flow communication a second source of sulfur dioxide with the second catalyst bed.

13. The apparatus as claimed in claim 12 wherein the second gas stream passage communicates with the second catalyst bed via the treated gas passage.

14. The apparatus as claimed in claim 12 wherein the concentration of sulfur dioxide in the second source of sulfur dioxide is higher than the concentration of sulfur dioxide in the first source of sulfur dioxide.

15. The apparatus as claimed in claim 12 wherein the concentration of sulfur dioxide in the second source of sulfur dioxide is greater than about 12% sulfur dioxide.

16. The apparatus as claimed in claim 12 wherein the first and second sources of sulfur dioxide are obtained from different stages of a smelting operation.

17. The apparatus as claimed in claim 12 wherein gas from the first source of sulfur dioxide is diluted to reduce the concentration of sulfur dioxide to a concentration at which the first catalyst bed will not overheat.

18. The apparatus as claimed in claim 12 further comprising a first dryer upstream from the first catalyst bed for drying gas from the first source of sulfur dioxide and a second dryer for drying gas from the second source of sulfur dioxide.

19. An apparatus comprising:
(a) a first catalyst bed;
(b) a first gas stream passage positioned upstream from the first catalyst bed and in fluid flow communication with the first catalyst bed, the first gas stream passage providing sulfur dioxide to the first catalyst bed, the first catalyst bed having a volume of catalyst which does not limit conversion of sulfur dioxide to sulfur trioxide;
(c) a second catalyst bed positioned downstream from the first catalyst bed;
(d) a treated gas passage connecting the first and second catalyst beds in fluid flow communication; and,
(e) a second gas stream passage positioned upstream from the second catalyst bed and in fluid flow communication with the second catalyst bed, the second gas stream passage providing sulfur dioxide, which has not passed through the first catalyst bed, to the second catalyst bed.

20. The apparatus as claimed in claim 19 wherein the second gas stream passage communicates with the second catalyst bed via the treated gas passage.

21. The apparatus as claimed in claim 19 wherein gas having a first concentration of sulfur dioxide is provided to the first catalyst bed and gas having a higher concentration of sulfur dioxide is provided to the second catalyst bed.

22. The apparatus as claimed in claim 21 wherein the first gas stream passage is in fluid flow communication with a different source of sulfur dioxide then the second gas stream passage.

23. The apparatus as claimed in claim 19 further comprising a first dryer upstream from the first catalyst bed and a second dryer upstream from the second catalyst bed.
